(19) United States
(12) Patent Application Publication
(10) Pub. No.: US 2007/0140283 A1
(43) Pub. Date: Jun. 21, 2007

(54) System and Method for IMS Bridging

(75) Inventors: Hua Huang, Shenzhen (CN); Yanfei Yang, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Huawei Technologies Co., LTd., Shenzhen (CN)

(21) Appl. No.: 11/613,301

(22) Filed: Dec. 20, 2006

Related U.S. Application Data
(63) Continuation of application No. PCT/CN06/01810, filed on Jul. 24, 2006.

(30) Foreign Application Priority Data
Jan. 10, 2006 (CN) 200610000282.0
Sep. 1, 2005 (CN) 200510093677.5

(51) Int. Cl. H04L 12/56

(52) U.S. Cl. 370/412; 370/395.52; 370/471

(57) ABSTRACT

A system for IMS bridging includes an I-CSCF, a BGCF, an S-CSCF and an MGCF; and a method for IMS bridging, including: a caller starting a call, and an I-CSCF routing the call according to a network where the caller locates. According to this invention, the MGCF and S-CSCF can only interwork with entities of the local network. Only the I-CSCF (or via the I-BCF) and BGCF can interwork with entities of external networks. Therefore, this invention can simplify the network and facilitate unified routing management. Alternatively, IP routing may be implemented via the I-BCF only and this also reduces the security risks of the network since the topology information is not exposed.

This application is a continuation of International Patent Application No. PCT/CN2006/001810, filed Jul. 24, 2006, which claims priority to Chinese Patent Application No. 200610000282.0, filed Jan. 10, 2006, and Chinese Patent Application No. 200510093677.5, filed Sep. 1, 2005, all of which are hereby incorporated by reference.

### FIELD OF THE INVENTION

The present invention relates to the communication technology, and more particularly, to a bridging system and a bridging method that may be used in the IP Multimedia Subsystem (IMS).

### BACKGROUND OF THE INVENTION

The IMS is a subsystem put forward by the 3^{rd} Generation Partnership Project (3GPP) in Release 5 to support IP multimedia services. As a Next Generation Network (NGN), the IMS adopts the Session Initiation Protocol (SIP) in the core, and is independent of the access technique. The IMS can be conveniently used to support real-time user-to-user mobile services such as multimedia voice and video telephony. It may support user-to-user communication services by using a series of mechanisms including session negotiation and management, Quality of Service (QoS) and mobility management. With the IMS technology, operators can also launch non-real-time user-to-user services (e.g. chat and instant messaging), multi-user services (e.g. multimedia conference and chat room) as well as server-to-user services (e.g. dynamic push and click-to-dial).

Because SIP is employed as the core processing protocol of the IMS, the IMS can provide a unified core network processing platform for Public Switched Telephony Network (PSTN) users, IMS users and other non-IMS SIP network users. The technique that uses the IMS domain as the unified processing platform to provide unified call control for the users of different networks is called “IMS Bridging”. As shown in FIG. 1, IMS bridging can provide unified call control for the interworking among IMS users, PSTN users and the users of another SIP network.

Several IMS bridging scenarios, as shown in Table 1, have been defined in prior e.g. the 3GPP standards). There are a number of entities in the IMS domain and a call request in each scenario is routed and forwarded by the number of the entities. The entities that have the routing function in the whole IMS domain include an Interrogating Call Session Control Function (I-CSCF), a Serving Call Session Control Function (S-CSCF), a Breakout Gateway Control Function (BGCF) and a Media Gateway Control Function (MGCF). Table 1 shows the defined IMS bridging scenarios.

TABLE 1

| Scenario | Caller | | | | | Callee |
|---|---|---|---|---|---|---|
| 1 | IMS user | S-CSCF | I-CSCF | S-CSCF | | IMS user |
| | (Operator A) | (Operator | (Operator | (Operator | | (Operator A) |
| | | A) | A) | A) | | |
| 2 | IMS user | S-CSCF | I-CSCF | S-CSCF | | IMS user |
| | (Operator | (Operator | (Operator | (Operator | | (Operator |
| | A) | A) | B) | B) | | B) |
| 3 | IMS user | S-CSCF | BGCF | | | PSTN user |
| | (Operator | (Operator | (Operator | | | connected |
| | A) | A) | A) | | | via MGCF |
| | | | | | | (Operator |
| | | | | | | A) |
| 4 | IMS user | S-CSCF | BGCF | | BGCF | PSTN user |
| | (Operator A) | (Operator | (Operator | | (Operator | connected |
| | | A) | A) | | B) | via MGCF |
| | | | | | | (Operator |
| | | | | | | B) |
| 5 | IMS user | S-CSCF | | | | Other SIP |
| | (Operator | (Operator | | | | network |
| | A) | A) | | | | user |
| 6 | MGCF | I-CSCF | | S-CSCF | | IMS user |
| | connecting | (Operator | | (Operator | | (Operator A) |
| | a PSTN | A) | | A) | | |
| | user | | | | | |
| | (Operator | | | | | |
| | A) | | | | | |
| 7 | Other SIP | I-CSCF | | S-CSCF | | IMS user |
| | network | (Operator | | (Operator | | (Operator |
| | user | A) | | A) | | A) |

The routing functions of the entities shown in Table 1 in the prior arts are described as follows:

I-CSCF: It has the incoming routing function and usually forwards the call request to the S-CSCF in the network (Scenarios 1, 2, 6 and 7).

S-CSCF: It has the outgoing routing function and may forward the call request to:
I-CSCF of the operator network if the callee is an IMS user and belongs to the same operator network as the S-CSCF (Scenario 1);
I-CSCF of the called operator network if the callee is an IMS user but belongs to a different operator network from the S-CSCF (Scenario 2);
BGCF of the network if the callee is a PSTN user (Scenarios 3 and 4);
A specific SIP network if the callee is a user of another SIP network (Scenario 5).

BGCF: It provides the routing function only when the callee is a PSTN user. It can have both the incoming and outgoing routing functions and may forward the call request to;
MGCF of the operator network if the callee belongs to the same operator network as the BGCF (Scenario 3);
BGCF of the called operator network if the callee belongs to a different operator network from the BGCF (Scenario 4).

MGCF: It provides the routing function only when the caller is a PSTN user.
The MGCF forwards the call request to the I-CSCF of the operator network if the callee is an IMS user and belongs to the same operator network as the MGCF (Scenario 6).

At present, an approach to add a tElephone NUmber Mapping (ENUM) to the MGCF has been put forward to enhance the routing function of the MGCF, in support of some other possible bridging scenarios. Thereby, the MGCF may have a routing function approximate to that of the S-CSCF and thus directly interwork with the BGCF, the I-CSCF of other operator networks as well as another SIP network (shown in Table 2).

TABLE 2

| Scenario | Caller | | | Callee |
|---|---|---|---|---|
| 8 | Other SIP | BGCF | | PSTN user |
| | network user | (Operator A) | | connected via |
| | | | | MGCF (Operator |
| | | | | A) |
| 9 | MGCF | I-CSCF | S-CSCF | IMS user |
| | connecting a | (Operator B) | (Operator B) | (Operator B) |
| | PSTN user | | | |
| | (Operator A) | | | |
| 10 | MGCF | | BGCF | PSTN user |
| | connecting a | | (Operator A) | connected via |
| | PSTN user | | | MGCF (Operator |
| | (Operator A) | | | A) |
| 11 | MGCF | BGCF | BGCF | PSTN user |
| | connecting a | (Operator A) | (Operator B) | connected via |
| | PSTN user | | | MGCF (Operator |
| | (Operator A) | | | B) |
| 12 | MGCF | | | Other SIP |
| | connecting a | | | network user |
| | PSTN user | | | |
| | (Operator A) | | | |

Where:

Scenario 8 indicates a call from a user of another SIP network to a PSTN user;

Scenario 9 indicates a call from a PSTN user to an IMS user (the caller and callee belong to different operators);

Scenario 10 indicates a call from a PSTN user to another PSTN user (the caller and callee belong to the same operator);

Scenario 11 indicates a call from a PSTN user to another PSTN user (the caller and callee belong to different operators);

Scenario 12 indicates a call from a PSTN user to a user of another SIP network.

FIG. 2 shows the routing interfaces between the entities in Scenarios 1 to 12. The numbers in the figure indicate some routing paths concerned in the scenarios that are numbered in Table 2. It can be seen that the I-CSCF, S-CSCF, BGCF and MGCF can all interwork with some entities of the local network (the same operator network) and external networks (other operator networks) if the existing bridging scheme is adopted.

### SUMMARY OF THE INVENTION

A system for IMS bridging including:

an Interrogating Call Session Control Function (I-CSCF), which determines whether a caller and a callee belong to a same operator and whether the caller or callee is a user of a PSTN, IMS network or other SIP network, and forwards a call request according to a judgment result of the determination; and

a Serving Call Session Control Function (S-CSCF), which connects with a plurality of IMS user terminals of a local operator network to a Breakout Gateway Control Function (BGCF) or I-CSCF of the local operator network.

A system for IMS bridging including:

an Interrogating Call Session Control Function (I-CSCF), which determines whether a caller and a callee belong to a same operator and whether the caller or callee is a user of a PSTN, IMS network or other SIP network, and forwards a call request according to a judgment result of the determination; and

a Media Gateway Control Function (MGCF), which connects with a plurality of PSTN user terminals of a local operator network to an I-CSCF of the local operator network.

A method for IMS bridging including:

a caller starting a call, and an I-CSCF routing the call according to a network where the caller locates.

An interrogating Call Session Control Function (I-CSCF) including:

a determination unit, which determines whether a caller and a callee belong to a same operator and whether the caller or callee is a user of the PSTN, IMS network or another SIP network; and

a transit unit, which forwards a call request according to a judgment result of the determination unit.

An Interconnect Border Control Function (I-BCF) including:

a transit unit, which receives a SIP message sent from an internal network node to an external network node, transfers the received SIP message to the external network node, receives an external SIP message from an external network, and transfers the received external SIP messages to a corresponding internal network node.

Therefore, the local network can interwork with the entities of external networks via the I-CSCF and BGCF according to the embodiment of this invention, thus reducing the number of interworking interfaces and simplifying the network. Alternatively, the local network may interwork with external networks via the new I-BCF only, thus further simplifying the network.

### BRIEF DESCRIPTION OF THE DRAWINGS

FIG. 1 is a schematic diagram of IMS bridging.

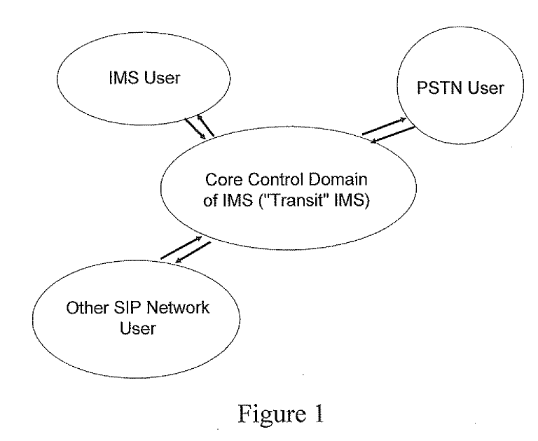

FIG. 2 shows a routing of a bridging system used in the prior arts.

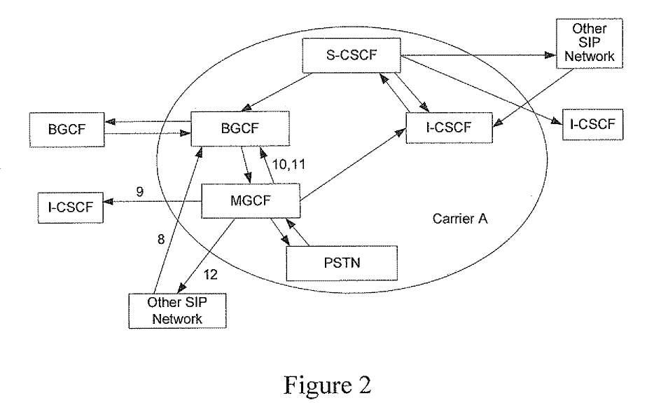

FIG. 3 shows a routing of a bridging system in an embodiment of the present invention.

FIG. 4 shows a routing of another bridging system in the embodiment of the present invention.

### DETAILED DESCRIPTION OF THE INVENTION

The present invention is hereinafter further described in detail with reference to the accompanying drawings as well as embodiments so as to make the technical schemes and merits thereof clearer.

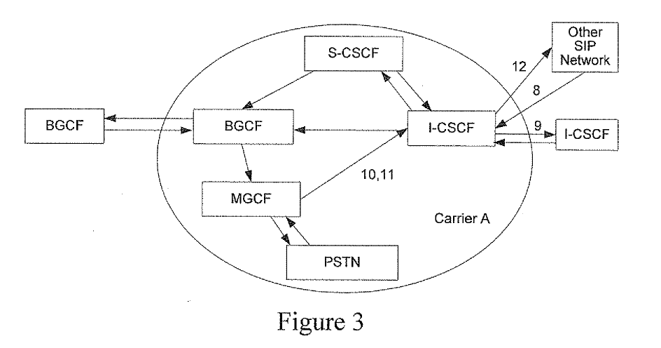

As shown in FIG. 3, the bridging system in an embodiment of the present invention includes an I-CSCF, a BGCF, an S-CSCF and a MGCF, of which only the I-CSCF and BGCF can interwork with external networks. The following describes the functions of these four entities based on FIG. 3.

The I-CSCF determines whether a caller and callee belong to a same operator and whether the caller or callee is a user of the PSTN, IMS network or another SIP network, so as to forward the call request accordingly. Specifically, the I-CSCF may connect a number of user terminals of another SIP network or other operators' IMS networks to a number of user terminals of the local network. When a PSTN user terminal of other networks communicates with a user terminal of the local network, the call request is forwarded first by the BGCF and then by the I-CSCF. When a PSTN user terminal of the local network communicates with another user terminal of the local network, the call request is forwarded first by the MGCF and then by the I-CSCF. The I-CSCF consists of a determination unit and a transit unit. The determination unit determines whether the caller and callee belong to a same operator and whether the caller or callee is a user of the PSTN or IMS network. The transit unit forwards the call request according to a judgment result of the determination unit.

The BGCF connects a number of user terminals of the local operator network to a number of PSTN user terminals of the local operator network or other operator networks.

The S-CSCF connects IMS user terminals of the local operator network to the BGCF or I-CSCF of the local operator network.

The MGCF connects PSTN user terminals of the local operator network to the I-CSCF of the local operator network.

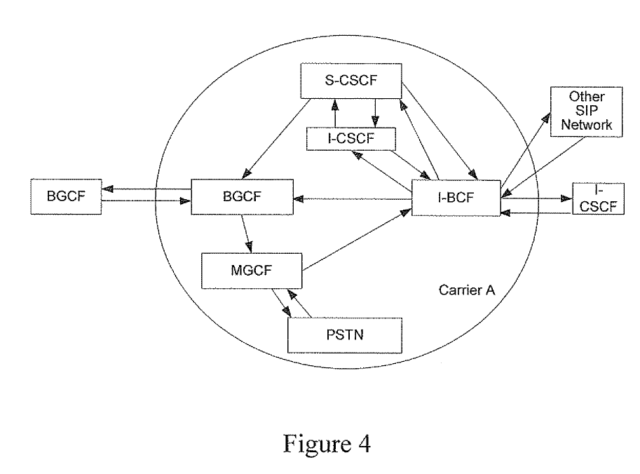

It is easy to understand that the transit unit of the I-CSCF is a logic unit that may be combined with the I-CSCF or MGCE or may be an independent physical entity. As shown in FIG. 4, the transit unit of the aforesaid I-CSCF is a completely independent Interconnect Border Control Function (I-BCF). It transfers the SIP messages sent or received according to the operator's configuration when the caller or callee does not belong to the local operator, so that the S-CSCF and I-CSCF do not need to directly communicate with external networks. Thereby, the topology information of the local network, such as the quantity, capability or address information of S-CSCFs, will not be exposed to external networks. Furthermore, as the boundary point that interworks with external networks, this function unit can integrate the ALG function. And this enables the application layer IP versions to interwork with each other when the IP version of the local network differs from that of other networks (e.g. one is an IPv6 network and the other is an IPv4 network). In addition, the unit can integrate the bearer control function so as to control the bearer resources during interworking. Therefore, SIP messages will be first forwarded to the I-BCF and then to the corresponding external network node when the function unit connecting the external SIP or IP network in the current network receives SIP messages destined for an external network. Similarly, all SIP messages from external networks are first sent to the I-BCF, which forwards these SIP messages to the corresponding internal network nodes. In sum, the I-BCF consists of: a) A transit unit, which transfers SIP messages, specifically, the SIP messages from internal network nodes to external network nodes and the SIP messages from external networks to internal networks, so as to shield the topology information of the networks; b) An ALG unit, which implements the interworking between application layer IP versions during network interworking; c) A bearer control unit, which controls the bearer resources during network interworking.

The I-BCF may be deployed in the ALG or I-CSCF or may exist independently. For the ease of description, it is supposed in the following implementation examples that the I-BCF is integrated in the I-CSCF.

In the bridging method according to the embodiment of this invention, the MGCF and S-CSCF can only interwork with entities of the local network. Only the I-CSCF and BGCF can interwork with entities of external networks. Therefore, the routing paths in some of Scenarios 1 to 12 will change according to the embodiment of this invention. Table 3 lists such scenarios.

TABLE 3

| Scenario | Caller | | | | | Callee |
|---|---|---|---|---|---|---|
| 2 | IMS user | S-CSCF | I-CSCF | I-CSCF | S-CSCF | IMS user |
| | (Operator A) | (Operator | (Operator | (Operator | (Operator | (Operator B) |
| | | A) | A) | B) | B) | |
| 5 | IMS user | S-CSCF | I-CSCF | | | Other SIP |
| | (Operator A) | (Operator | (Operator | | | network user |
| | | A) | A) | | | |
| 8 | Other SIP | | I-CSCF | | BGCF | PSTN user |
| | network user | | (Operator | | (Operator | connected |
| | | | A) | | A) | via MGCF |
| | | | | | | (Operator A) |
| 9 | MGCF | | I-CSCF | I-CSCF | S-CSCF | IMS user |
| | connecting a | | (Operator | (Operator | (Operator | (Operator B) |
| | PSTN user | | A) | B) | B) | |
| | (Operator A) | | | | | |
| 10 | MGCF | | I-CSCF | | BGCF | PSTN user |
| | connecting a | | (Operator | | (Operator | connected |
| | PSTN user | | A) | | A) | via MGCF |
| | (Operator A) | | | | | (Operator A) |
| 11 | MGCF | | I-CSCF | BGCF | BGCF | PSTN user |
| | connecting a | | (Operator | (Operator | (Operator | connected |
| | PSTN user | | A) | A) | B) | via MGCF |
| | (Operator A) | | | | | (Operator B) |
| 12 | MGCF | | I-CSCF | | | Other SIP |
| | connecting a | | (Operator | | | network user |
| | PSTN user | | A) | | | |
| | (Operator A) | | | | | |

As shown in Table 3, the I-CSCF implements the transit function in these routing scenarios. It completes the routing function that is originally implemented by the S-CSCF or the MGCF to which ENUM is added. In FIG. 3, the numbers indicate some routing paths in Scenarios 8 to 12 in the embodiments of this invention. The following takes Scenarios 2, 9 and 11 as examples to describe the routing process.

Scenario 2: An IMS user calls another IMS user (the caller and the callee belong to different operators). Upon receipt of the request message from the IMS user, the S-CSCF determines that the callee is not a PSTN user and so forwards the request to the I-CSCF. The I-CSCF finds that the callee belongs to a different operator from the caller, so it forwards the request message to the I-CSCF of the called operator. The I-CSCF of the called operator interacts with the HSS and gets the called S-CSCF address. Finally, the called S-CSCF forwards the request to the callee.

Scenario 9: A PSTN user calls an IMS user (the caller and the callee belong to different operators). Upon receipt of the request message from the PSTN user, the MGCF directly forwards the request to the I-CSCF. The I-CSCF finds through the ENUM mechanism that the callee belongs to a different operator from the caller, so it forwards the request message to the I-CSCF of the called operator. The I-CSCF of the called operator interacts with the HSS and gets the called S-CSCF address. Finally, the called S-CSCF forwards the request to the callee.

Scenario 11: A PSTN user calls another PSTN user (the caller and the callee belong to different operators). Upon receipt of the request message from the PSTN user, the MGCF directly forwards the request to the I-CSCF. The I-CSCF finds through the ENUM mechanism that the callee is a PSTN user, so it forwards the request message to the BGCF. The BGCF determines that the callee belongs to a different operator from the caller, so it forwards the request message to the called BGCF. Finally, the called BGCF forwards the request to the called PSTN user.

The following describes the functions of the I-CSCF, BGCF, S-CSCF and MGCF based on FIG. 3 and Table 3.

The I-CSCF integrates many routing functions and can interwork with entities of the local network and entities of external networks. The scenarios of routing may be:

When the caller is an IMS user:

The I-CSCF forwards the call request to the S-CSCF of the local operator network if the callee is an IMS user and belongs to the same operator as the caller;

The I-CSCF forwards the call request to the I-CSCF of the called operator network if the callee is an IMS user and belongs to a different operator from the caller;

The I-CSCF directly forwards the call request to a specific SIP network if the callee is a user of another SIP network.

When the caller is a PSTN user:

The I-CSCF forwards the call request to the S-CSCF of the local operator network if the callee is an IMS user and belongs to the same operator as the caller;

The I-CSCF forwards the call request to the I-CSCF of the called operator network if the callee is an IMS user and belongs to a different operator from the caller;

The I-CSCF forwards the call request to the BGCF of the local network if the callee is a PSTN user;

The I-CSCF directly forwards the call request to a specific SIP network if the callee is a user of another SIP network.

When the caller is a user of another SIP network:

The I-CSCF forwards the call request to the S-CSCF of the local network if the callee is an IMS user;

The I-CSCF forwards the call request to the BGCF of the local network if the callee is a PSTN user.

The routing functions of the BGCF are the same as the existing technologies described in Table 1. So no further description is provided.

The S-CSCF can only interwork with entities of the local network and may forward a call request to:

BGCF of the local network if the callee is a PSTN user;

I-CSCF of the local network if the callee is not a PSTN user.

The MGCF provides the routing function only when the caller is a PSTN user. In whichever scenario, it forwards the call request to the I-CSCF of the local network.

Therefore, only the I-CSCF and BGCF in the local network interwork with entities of external networks according to the embodiments of this invention, thus reducing the number of interworking interfaces and simplifying the network. In whatever case, the MGCF forwards the call request to the I-CSCF so as to route the call to another SIP network. For this reason, the I-CSCF integrates many routing functions, contributing to unified routing management. Moreover, only the BGCF and I-CSCF work as external routing points and this also reduces the security risks of the network since the topology information is not exposed.

The foregoing is only the preferred embodiments of the present invention and is not intended to limit the scope of the present invention. Any modification, equivalent substitution, or improvement made without departing from the spirit and principle of the present invention should be covered by the scope set forth in the appended claims.

What is claimed is:

1. A system for IMS bridging, comprising:
an Interrogating Call Session Control Function (I-CSCF), which determines whether a caller and a callee belong to a same operator and whether the caller or callee is a user of a PSTN, IMS network or other SIP network, and forwards a call request according to a judgment result of the determination; and
a Serving Call Session Control Function (S-CSCF), which connects with a plurality of IMS user terminals of a local operator network to a Breakout Gateway Control Function (BGCF) or I-CSCF of the local operator network.

2. The system for IMS bridging as claimed in claim 1, wherein the I-CSCF comprises:
a determination unit, which determines whether the caller and the callee belong to the same operator and whether the caller or callee is a user of the PSTN, IMS network or other SIP network; and
a transit unit, which forwards the call request according to the judgment result of the determination unit.

3. A system for IMS bridging, comprising:
an Interrogating Call Session Control Function (I-CSCF), which determines whether a caller and a callee belong to a same operator and whether the caller or callee is a user of a PSTN, IMS network or other SIP network, and forwards a call request according to a judgment result of the determination; and
a Media Gateway Control Function (MGCF), which connects with a plurality of PSTN user terminals of a local operator network to an I-CSCF of the local operator network.

4. The system for IMS bridging as claimed in claim 3, further comprising:
a Breakout Gateway Control Function (BGCF), which connects a plurality of user terminals of the local operator network to the plurality of PSTN user terminals of the local operator network or other operator network.

5. The system for IMS bridging as claimed in claim 4, wherein the I-CSCF comprises:
a determination unit, which determines whether the caller and the callee belong to the same operator and whether the caller or callee is a user of a PSTN, IMS network or other SIP network; and
a transit unit, which forwards the call request according to the judgment result of the determination unit.

6. The system for IMS bridging as claimed in claim 3, wherein the I-CSCF comprising:
a determination unit, which determines whether the caller and the callee belong to the same operator and whether the caller or callee is a user of a PSTN, IMS network or other SIP network; and
a transit unit, which forwards the call request according to the judgment result of the determination unit.

7. A method for IMS bridging, comprising:
a caller starting a call, and an I-CSCF routing the call according to a network where the caller locates.

8. The method for IMS bridging as claimed in claim 7, wherein:
when the caller is an IMS user, the I-CSCF routes the call according to a network where the callee locates;
when the caller is a PSTN user, the I-CSCF routes the call according to the network where the callee locates; and
when the caller is a user of other SIP network, the I-CSCF routes the call according to the network where the callee locates.

9. The method for IMS bridging as claimed in claim 8, wherein the scenario of when the caller is an IMS user the I-CSCF routing the call according to a network where the callee locates comprises:
the I-CSCF forwards a call request to a called S-CSCF of the local operator network when the callee is an IMS user and belongs to a same operator as the caller;
the I-CSCF forwards a call request to an I-CSCF of a called operator network when the callee is an IMS user but belongs to a different operator from the caller; and
the I-CSCF forwards a call request to a specific SIP network when the callee is a user of other SIP network.

10. The method for IMS bridging as claimed in claimed 8, wherein the scenario of when the caller is a PSTN user the I-CSCF routing the call according to the network where the callee locates comprises:
the I-CSCF forwards a call request to a called S-CSCF of the local operator network when the callee is an IMS user and belongs to a same operator as the caller;
the I-CSCF forwards a call request to an I-CSCF of a called operator network when the callee is an IMS user but belongs to a different operator from the caller;
the I-CSCF forwards a call request to a BGCF of the local operator network when the callee is a PSTN user; and
the I-CSCF forwards a call request to a specific SIP network when the callee is a user of other SIP network.

11. The method for IMS bridging as claimed in claim 8, wherein the scenario of when the caller is a user of other SIP network the I-CSCF routing the call according to the network where the callee locates comprises:
the I-CSCF forwards a call request to a S-CSCF of a called network when the callee is an IMS user;
the I-CSCF forwards a call request to a BGCF of the local operator network when the callee is a PSTN user.

12. An Interrogating Call Session Control Function (I-CSCF), comprising:
a determination unit, which determines whether a caller and a callee belong to a same operator and whether the caller or callee is a user of the PSTN, IMS network or other SIP network; and
a transit unit, which forwards a call request according to a judgment result of the determination unit.

13. An Interconnect Border Control Function (I-BCF), comprising:
a transit unit, which receives a SIP message sent from an internal network node to an external network node, transfers the SIP message to the external network node, receives an external SIP message from an external network, and transfers the external SIP message to a corresponding internal network node.

14. The I-BCF as claimed in claim 13, further comprising:
an Application Layer Gateway (ALG) unit, which implements an interworking between different IP versions.

15. The I-BCF as claimed in claim 14, further comprising:
a bearer control unit, which controls the bearer resources during network interworking.

16. The I-BCF as claimed in claim 15, wherein the I-BCF independently exist or is integrated in the I-CSCF or the ALG.

17. The I-BCF as claimed in claim 14, wherein the I-BCF independently exist or is integrated in the I-CSCF and/or the ALG.

18. The I-BCF as claimed in claim 13, further comprising:
a bearer control unit, which controls the bearer resources during network interworking.

19. The I-BCF as claimed in claim 18, wherein the I-BCF independently exist or is integrated in the I-CSCF or the ALG.

20. The I-BCF as claimed in claim 13, wherein the I-BCF independently exist or is integrated in the I-CSCF and/or the ALG.
